(19) United States
(12) Patent Application Publication
(10) Pub. No.: US 2026/0153287 A1
(43) Pub. Date: Jun. 4, 2026

(54) HEATING DEVICE

(71) Applicant: SOKOTHERM GmbH, Bremberg (DE)

(72) Inventors: Marcel Hering, Hachenburg (DE); Marco Herzmann, Salz (DE)

(73) Assignee: SOKOTHERM GmbH, Bremberg (DE)

(21) Appl. No.: 18/964,002

(22) Filed: Nov. 29, 2024

(51) Int. Cl. F28D 1/00; F24D 19/00; F28F 1/16

(52) U.S. Cl. CPC F28D 1/00; F24D 19/0002; F28F 1/16; F24D 2220/06; F28F 2255/16

(57) ABSTRACT

The invention relates to a heating device (10) comprising at least one heating module (100) having first and second sides (110, 120) which are each substantially straight and parallel to each other, the heating module (100) having a third side (130) with a plurality of first fins and a fourth side (140) with a plurality of second fins and an arm (141) spaced apart from the second fins, the heating module having first and second longitudinal bores (170, 180) for receiving a heating medium, each heating module (100) having a one-piece heating element (140) spaced apart from the second fins, which is provided at a distance from the second fins, the heating module having a first and second longitudinal bore (170, 180) for receiving a heating medium, each heating module (100) being produced in one piece in the form of an aluminum extrusion process.

The present invention relates to a heating device and a connecting piece for such a heating device.

Finned heating systems or underfloor heating systems are typically used to heat buildings. It is often not possible to retrofit underfloor heating. An alternative option for heating rooms is to use heating device or a skirting heating system.

A skirt heating system is in particular an essentially flat heating element, which preferably has the shape of a skirting board.

WO 2019/037923 A1 shows a corresponding heating device. The heating device has various modules which, when assembled and function as a heating unit. The modules can be made of metal and can have slats. They can be attached to a wall of the room to be heated. A cover element can then be placed on the modules. The cover element is a metal sheet and has an inclined section in the upper area, which is intended to allow heated air to be directed to a room wall to which the heating strip is attached. The skirting heating modules can be attached to wall brackets. Two of the three modules have a longitudinal hole, which is used to take hot water as the flow and colder water as the return.

It is a task of the present invention to provide a heating device which has improved impact resistance and improved efficiency.

This task is solved by a heating device according to claim 1.

According to one aspect of the present invention, the heating device has at least one one-piece heating module. Holes for the hot water supply and holes for the return are provided in this heating module. The module may have first and second opposite and substantially parallel sides. The first side can be attached to a wall of the room to be heated using brackets. The first side is essentially straight and can optionally be corrugated or smooth. The second side is also essentially straight and can optionally be corrugated or smooth. A plurality of first slats is provided on a third side (between the first and second sides). A fourth side (between the first and second sides) also has a plurality of second slats and an arm. In the assembled state, the third side points downwards and the fourth side points upwards. The arm thus rep-resents an upper end of the module. There is a gap between the arm and the fins on the fourth side, so that an air volume is formed here. The heating module is manufactured in one piece in aluminum extrusion presses.

The design of the heating module and in particular the provision of the arm on the fourth side (top) is advantageous, as this improves the impact resistance of the heating device. The mechanical stability of the heating module is also improved. Furthermore, the risk of injury from the heating module is significantly reduced due to its compact design and the provision of the arm.

According to one aspect of the present invention, the arm has a straight surface on one outer side and a curved surface on the opposite side. The curved surface is opposite the slats of the fourth end and defines the volume between the arm and the slats of the fourth end.

According to one aspect of the present invention, the mass of the heating module is between two and three kilograms per meter, preferably 2.44 kg per meter. A water content of a module is between 0.4 and 0.6 liters per meter and in particular 0.51 liters per meter.

According to one aspect of the present invention, the thermal output of a module is between 120 and 140 watts per meter and in particular approximately 130 watts per meter.

According to one aspect of the present invention, the heating device has at least one heating module which can be attached to a wall via retaining brackets. The mounting brackets have a base which can be placed on the floor of the room. The body of the mounting bracket is then screwed to a wall. The heating modules can then be placed on the bracket base.

According to a further aspect of the present invention, the heating device has at least one and preferably two retaining springs, which are used to secure pipe connections of two heating modules or between the first and second longitudinal bores. One retaining spring is used to secure connecting pipes to the heating circuit and a second retaining spring is used to secure a bypass.

According to one aspect of the present invention, the retaining springs can be made of plastic.

According to one aspect of the present invention, the retaining brackets serve on the one hand to secure the heating modules. Furthermore, however, these brackets also provide a distance between the heating modules from the floor and the wall in order to allow circulation of the heated air. The retaining brackets can have arms which are used to be fastened in corresponding recesses in the heating module.

The design of the heating module (and in particular the arm) improves the handling of the module during installation. In particular, it is easier to cut the heating module to the required length. According to one aspect of the invention, the arm serves to direct the air, i.e. to direct the heated air.

According to one aspect of the invention, the weight of the radiator should not be too high so that the radiator can still be mounted. There is thus a trade-off between thermal conductivity and ease of installation.

According to one aspect of the invention, the skirting heating can improve indoor air hygiene by selectively heating the plinth area. For example, this can make it possible to raise the temperature in the base area. In uninsulated old buildings, this can prevent the temperature from falling below the dew point in external walls in contact with the ground.

The air is guided along the wall through the arm. As a result, the wall is not only heated in the area of the plinth, but over the entire height, preventing the temperature from falling below the dew point in the corners below the wall, which prevents mold.

The connecting pieces described herein are intended in particular for the corners (of a room).

The connecting pieces not only enable the installation of the skirting heating described herein, for example in corners, but also serve as a compensator for the linear expansion of the profile or for any installation errors.

This task is solved by a connecting piece according to claim 11.

According to one aspect, the connecting piece comprises a first connecting element and a second connecting element, wherein the first connecting element and the second connecting element can be connected to one another in a fluid-conducting manner via a bayonet lock.

The connecting piece is therefore particularly multi-part and is designed to conduct the heating medium from one heating module to another heating module. Preferably, the connecting piece or the connecting elements and the bayonet catch are made of metal and/or plastic.

The term ‘connecting piece’ is used here to refer to pipes that are primarily used to make pipeline connections. The dimensions of many fittings are defined in standards (EN, ANSI, GOST . . . ) so that pipes and fittings from different manufacturers can be combined. Pipe connectors of larger dimensions or with lower demands on fitting accuracy are also referred to as fittings, especially those made of plastic.

A bayonet lock or bayonet catch is a mechanical connection between two cylindrical parts along their longitudinal axis that can be made and released quickly. The parts are connected and disconnected by pushing one into the other and turning in opposite directions. The part that is pushed over the other has a longitudinal slot, at the end of which a short transverse slot is attached at right angles. The other part, on the other hand, has a knob that is inserted into the transverse slot and then creates the fixed connection. The connection is made using a push-and-turn movement: The two parts to be connected are inserted into each other; approximately perpendicular to the direction of insertion, elongated protrusions are provided in both parts at the connection point. However, these do not run all the way around, but are interrupted (otherwise it would not be possible to plug them into each other). As the protrusions are now at a slight angle in the plane perpendicular to the insertion direction, both parts are pressed against each other by a rotary movement. The bayonet catch therefore works like a thread. Sometimes (for example with camera lenses) a catch is also used to secure the connection. As an alternative to moving the interlocking rails, an appropriately shaped indentation can also be used on one part and a bulge on the other (e.g. for BNC connectors).

According to a further aspect, the bayonet catch is an integral part of the first and second connecting element. For this purpose, the first connecting element has, for example, a bayonet ring with openings and the second connecting element has bayonet pins that match the openings.

According to a further aspect, the bayonet catch is designed in such a way that the second connecting element comes to rest in the first connecting element. For this purpose, the first connecting element has, for example, an inner end which has a larger diameter than the corresponding inner end of the second connecting element.

According to a further aspect, the bayonet catch is designed in such a way that the second connecting element comes into contact with the first connecting element in a fluid-conducting manner.

According to a further aspect, the bayonet catch is designed in such a way that the second connecting element has a longitudinal play in the first connecting element, which is orthogonal to an axis of rotation of the bayonet catch. Due to this longitudinal play, the connecting element also serves as a compensator for the longitudinal expansion of the profile or for any assembly errors. The longitudinal expansion of the profile is caused in particular by the heating medium, which mentions the fluid-conducting profiles accordingly and thus leads to an expansion of the profiles. Due to the design of the bayonet fitting, the compensation can take place continuously, in particular because the elements can also move horizontally in relation to each other after installation. In particular, the bayonet lock proposed herein therefore enables constant adjustment during operation, in contrast to one-time adjustable compensation part or a sleeve.

According to a further aspect, the first connecting element and/or the second connecting element is essentially tubular or cylindrical in shape.

According to a further aspect, the second connecting element has a curving or curvature. The curvature can be arbitrary. In particular, the curvature is based on the corner or the wall. Preferably, the curvature is essentially 30°, 45° or 90°. Preferably, the curvature is freely adjustable and can move freely during operation.

According to a further aspect, the first connecting element has a taper which is adapted to come to rest in a fluid-conducting manner in a longitudinal bore of a heating module of the heating device, as described herein.

According to a further aspect, the connecting piece is designed as a pipe connector or fitting to connect two heating modules of a heating device at an angle.

According to a further aspect, the connecting elements are connected to each other in a fluid-conducting manner and/or sealed by means of sealing rings.

Further embodiments of the invention are the subject of the further claims.

According to a further aspect of the invention, the heating device enables a more homogeneous temperature distribution over the height of the room. In particular, the local feeling of comfort can be improved.

According to a further aspect of the invention, an outer side of the arm has an angle to the second side of between 90° and 100°.

According to a further aspect of the invention, the heating device has at least one retaining bracket which can be attached to a wall (800). The at least one retaining bracket is attached to the first side of the heating module, so that there is a distance between the first side of the heating module and the wall, which distance is determined by the retaining bracket.

Further embodiments of the invention are the subject of the further claims.

Advantages and embodiments of the invention are explained in more detail below with reference to the drawing.

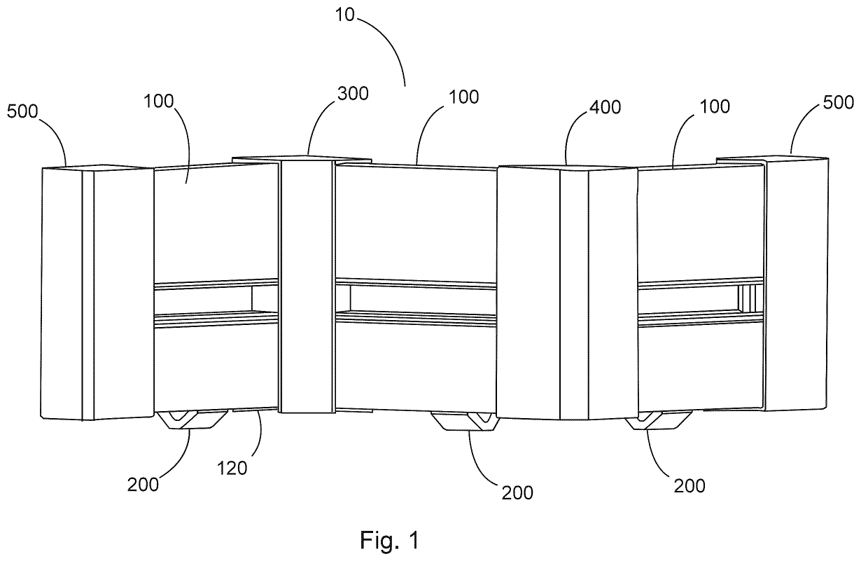

FIG. 1 shows a schematic and perspective view of a heating device according to a first embodiment of the invention,

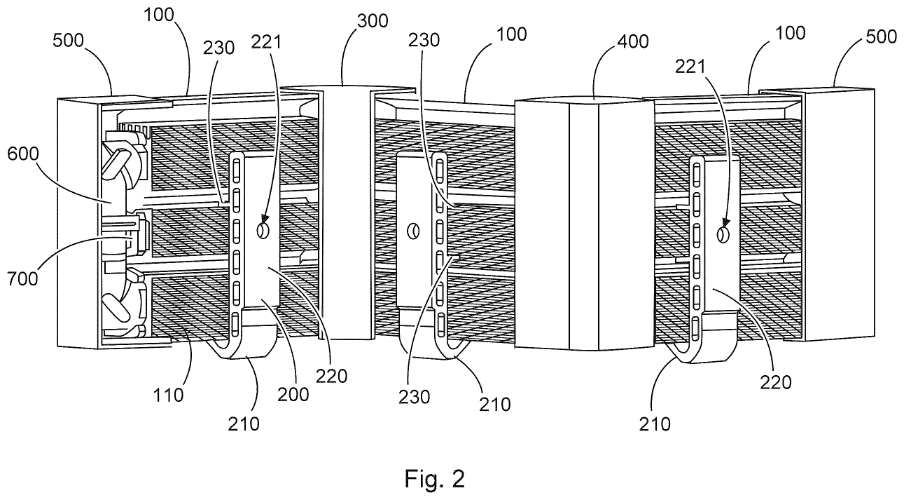

FIG. 2 shows a perspective and schematic representation of a rear side of a heating device according to the first embodiment example,

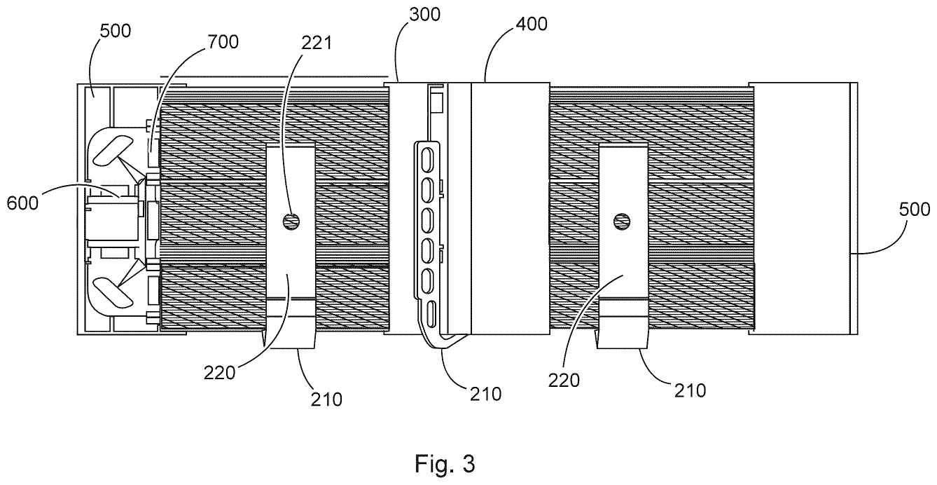

FIG. 3 shows a further schematic view of a rear side of the heating device according to the first embodiment example,

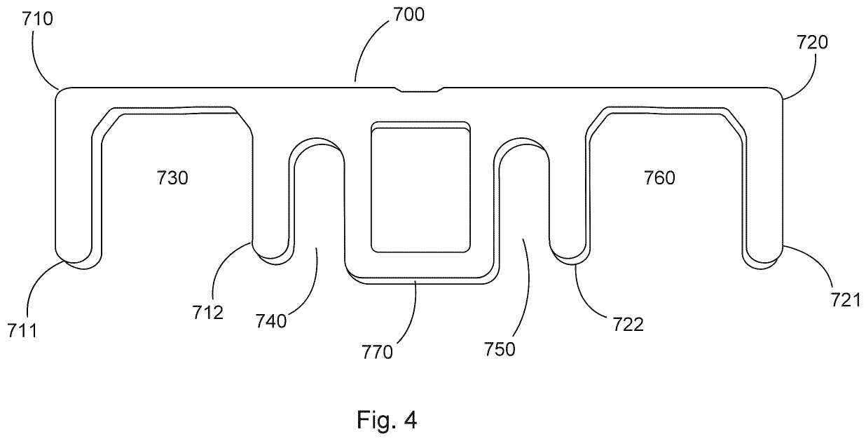

FIG. 4 shows a view of a retaining spring for a heating device according to the first embodiment example,

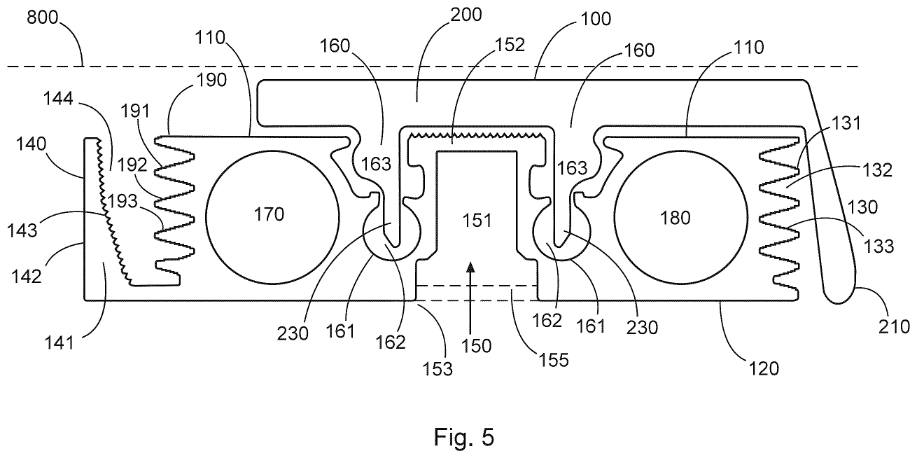

FIG. 5 shows a schematic cross-section of a heating module for a heating device according to the first embodiment example,

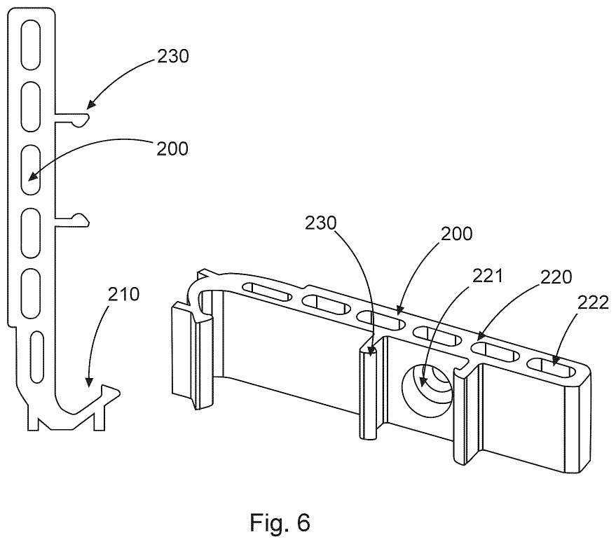

FIG. 6 shows a view of a retaining bracket according to the invention

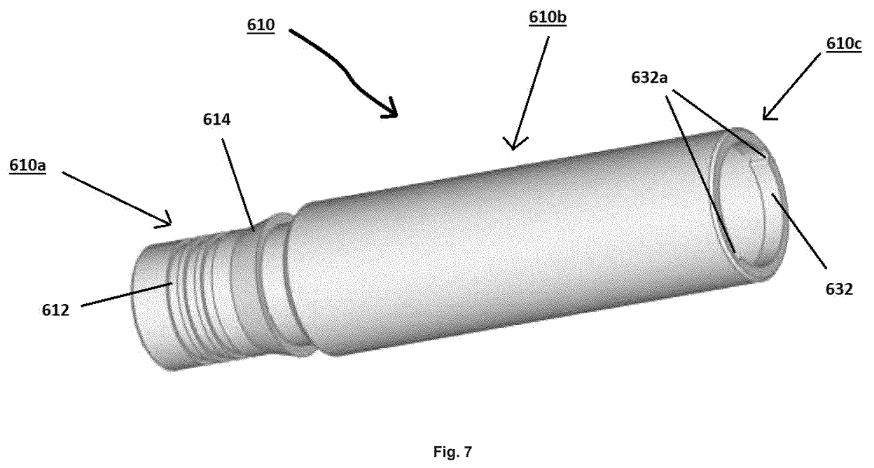

FIG. 7 shows a first connecting element in one embodiment,

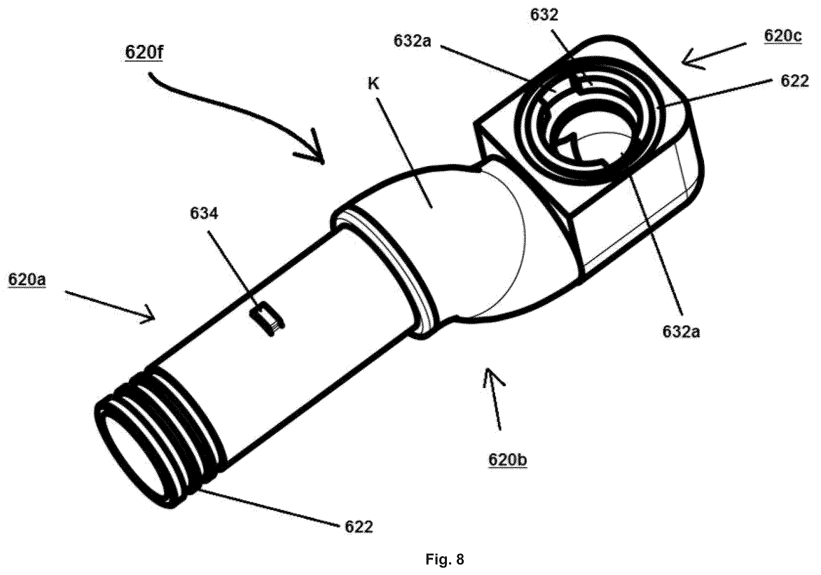

FIG. 8 shows a second connecting element in a first embodiment,

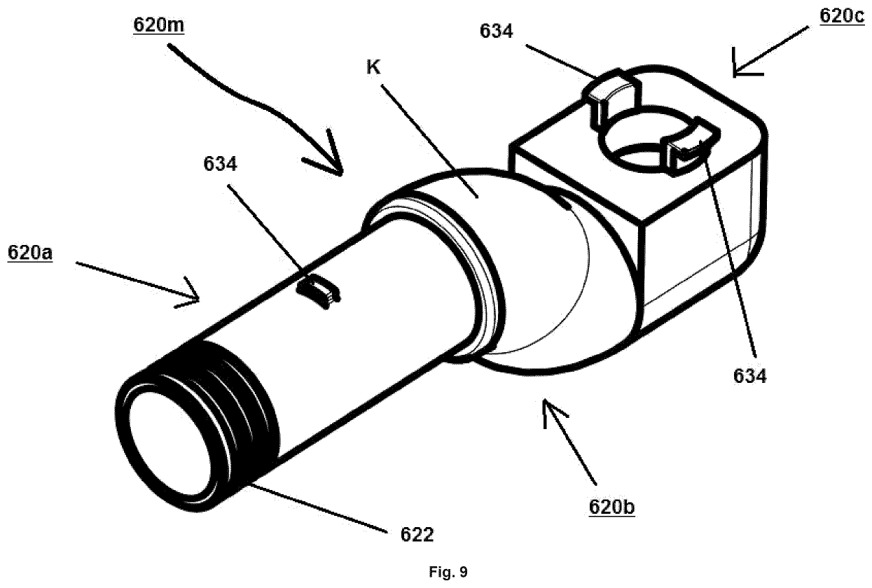

FIG. 9 shows a second connecting element in a second embodiment,

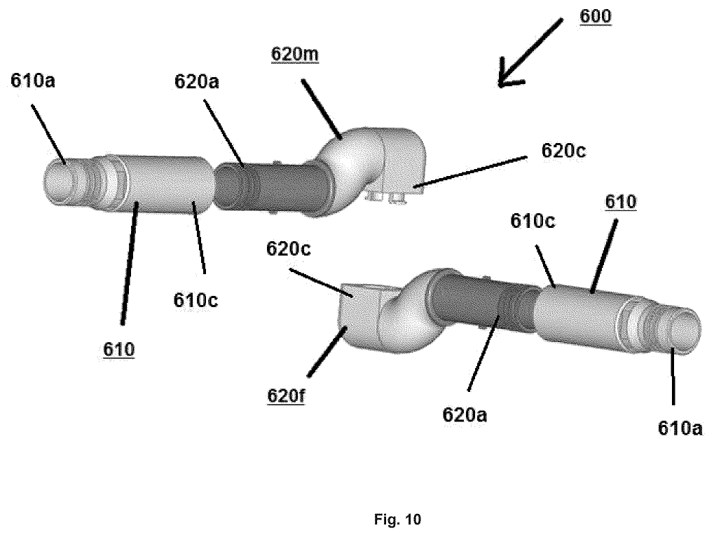

FIG. 10 shows a connecting piece in a preferred embodiment, and

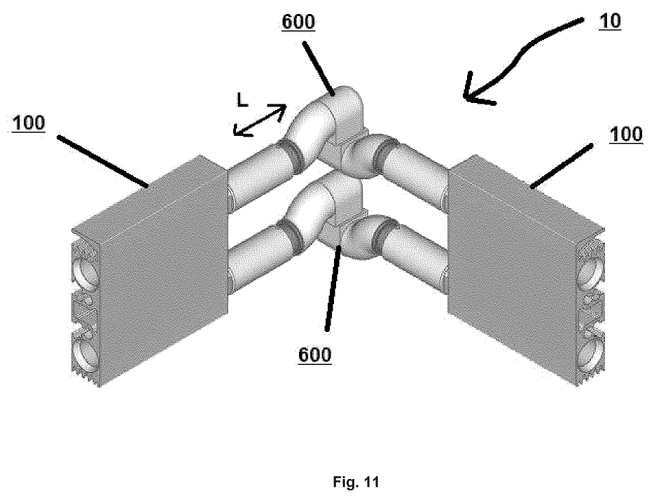

FIG. 11 shows a heating device in a further embodiment.

FIG. 1 shows a schematic and perspective view of a heating device according to a first embodiment of the invention. The heating device 10 has at least one heating module 100, optionally corner covers 300, 400, optionally end caps 500 and a plurality of retaining brackets 200.

FIG. 1 shows the front of a heating device and FIGS. 2 and 3 show the rear of the heating device from two different perspectives.

The heating device in FIG. 1 is merely an exemplary representation of the heating device. The heating modules 100 have recesses on their rear side, which are used to attach them to a retaining bracket 200. The retaining bracket 200 has a base 210 and a retaining body 220 with a hole 221. Further, the retaining bracket 200 may include a plurality of arms 230 that may be secured in recesses on a rear side of the heating module 100. In other words, a heating module can be placed on the retaining base 210 after the retaining bracket is mounted to a wall 800 and the rear of the heating module 100 can be mounted using the arms of the retaining bracket 200. The thickness of the holding body 220 of the holding bracket 200 determines the distance between the heating module and the wall 800.

The heating module 100 has a first and a second longitudinal bore for holding the heating medium, e.g. water. Pipe connectors and fittings 600 can be provided at one end of a heating module, which can be held by means of the retaining spring 700. The retaining spring 700 can prevent unintentional removal of the pipe connectors.

FIG. 4 shows a view of a retaining spring for a heating device according to the first embodiment example. In particular, a retaining spring 700 is shown in FIG. 4. The retaining spring 700 has a first end 710 and a second end 720. A first arm 711 is provided at the first end 710 and a second arm 721 is provided at the second end 720. Furthermore, a third arm 712 is provided parallel to the first arm 711 and a fourth arm 722 is provided parallel to the second arm 721. A middle section 770 may be provided substantially in the middle of the retaining spring 700. A first section 730 may be provided between the first and third arms 711, 712 and a second section 740 may be provided between the third arm 712 and the center section 770. A third section 760 may be provided between the middle section 770 and the fourth arm 722 and a fourth arm 760 may be provided between the second and fourth arms 721, 722.

Optionally, the retaining spring 700 can be made of plastic. This is advantageous because it prevents noise between the retaining spring and the pipe connectors during operation of the heating device due to different coefficients of thermal expansion.

FIG. 5 shows a cross-section of a heating module 100. The heating module 100 has a first side 110 (rear side), a second side 120 (front side), a third side 130 (lower side) and a fourth side 140 (upper side). The first side 110 is substantially straight. The first side 110 can be smooth or have a corrugation. The second side 120 is also substantially straight and is arranged parallel to the first side 110. The first side 110 may be smooth or have corrugations. A first and second longitudinal bore 170, 180 are provided between the first and second sides 110, 120. These bores 170, 180 serve to accommodate the heating fluid, for example water.

The third side 130 has a plurality of first slats 131. These first slats have slat crests 133 and slat valleys 132. Optionally, one surface of the fins can have further smaller third fins. This serves to increase the surface area of the heating module.

Optionally, a middle section 150 and two fastening sections 160 may be provided between the two longitudinal bores 170, 180. The fastening sections 160 are open towards the first side 110 and the middle section 150 can be open towards the second side 120. Optionally, the middle section 150 may be closed. Optionally, the center section 150 may be closed, for example, by a web 155 (shown dashed in FIG. 5). In this case, the second side 120 is continuous.

Analogous to the third side 130, the fourth side 140 has a plurality of second lamellae 190 with lamella crests 191 and lamella valleys 192. The surfaces of these lamellae can have further third lamellae 193 to increase the surface area. Furthermore, the fourth side 140 has an arm 143 which extends from the second side 120 towards the first side 110. The arm 141 has a smooth surface on its outer side 142 and a curved section 143 towards the inside. Optionally, the curved section 143 can have further slats to increase the surface area. A volume 144 is present between the curved section 143 and the slats 190 of the first end.

Optionally, the length of the arm 141 substantially corresponds to the depth of the heating module so that a volume of air 144 is confined by the curved portion 143 and the fins 190 when the heating module is mounted.

The sections 160 optionally serve to accommodate the holding arms 230 of the holding bracket 200.

The section 150 may have a first end 152 and a volume 151 with an open second end 155. The section 150 can be used to accommodate cables or lighting elements. Optionally, the middle section 150 or its second end 153 can have a web 155 that closes the volume 151.

The outer side 142 of the arm 140 may have an angle to the second side 120 of between 90° and 100°.

The design of the arm 140, which optionally extends over the entire depth of the heating module 100, can significantly reduce dirt or dust in the heating module. Dirt and, in particular, dust then fall onto the arm 140. The arm 140 can thus effectively keep out dirt and dust. The dirt and dust can be easily removed from the arm 140. Dirt and dust can only enter the interior of the heating module 110 through the gap between the heating module and the wall. This gap is defined by the thickness of the retaining body 200 of the retaining bracket. If too much dust should nevertheless get into the interior of the heating module (in particular into the volume between the fins 190 and the arm 141), this dust can be removed by a vacuum cleaner positioned at the gap.

By providing the arm on the upper side of the heating module, the heating performance of the module is not impaired in the long term. Otherwise, dust may accumulate on the second fins, which can impair the heat transfer at the transition be-tween the fins and the air.

The arm is advantageously used to direct heated air towards the wall.

FIG. 6 shows a view of a retaining bracket according to the invention. The retaining bracket 200 has a retaining foot 210, a retaining body 220, a bore 221 and arms 230. Recesses or bores 222 can be provided in the retaining body 220 from both sides or from one side.

The retaining bracket 200 can be attached to a wall 800 using the hole 221 and a screw, for example. The thickness or depth of the retaining body 220 determines the distance of the heating module 100 from the wall 800.

Optionally, the bracket is not fixed over the entire surface of the module. Instead, the mounting bracket can be attached to the wall at a distance of 1 m, for example. In this way, the mounting of the heating module differs from the mounting of heating modules in the state of the art, where the mounting technology is attached over the entire length of the strip. The distance between the brackets in our heating module further promotes air circulation, as there are no brackets in the way. It also al-lows wall unevenness to be compensated for during installation.

Optionally, the heating module 100 can be manufactured using an aluminum extrusion press. The weight of the heating module is between 2 and 3 kilograms per meter, in particular 2.44 l/m. The water content of a heating module can be between 0.4 and 0.6 liters per meter, in particular approx. 0.5 l/m.

According to one aspect of the present invention, the height of the heating module is between 80 and 110 mm. Preferably, the height of the module is between 90 and 100 mm, and in particular 97 mm. Optionally, a total length of a module may be between 3000 and 6000 mm. Preferably, the total length of the module is 5000 mm.

According to one aspect of the present invention, the depth of the module is between 15 and 30 mm and in particular approximately 20 mm.

A standard heat output of a module can be between 400 and 700 watts. A specific standard heat output of a heating module is approx. 130 watts per meter.

According to one aspect of the invention, the following parameters were determined during a test of the heating module: Exponent n=1.2102, constant Km=3.675, specific constant K_{mL}=1.148, specific standard heat output W/m=131, and specific standard low-temperature heat output=70.4W/m. The following applies to the heat output Φ=Km ΔTⁿ [W]

According to one aspect of the invention, the skirting heating can improve indoor air hygiene by selectively heating the plinth area. For example, this can make it possible to raise the temperature in the base area. In the case of uninsulated old buildings, this can prevent the temperature from falling below the dew point in external walls in contact with the ground. This has a beneficial effect on reducing the growth of mold.

According to a further aspect of the invention, the heating device enables a more homogeneous temperature distribution over the height of the room. In particular, the local feeling of comfort can be improved.

FIG. 7 shows a first connecting element 610 in one embodiment.

The first connecting element 610 is essentially designed as a cylindrical body 610b and has an outer end 610a and an inner end 610c.

The outer end 610a comprises a taper 614, which is in particular designed to come to rest in a longitudinal bore 170, 180 of a heating module 100 of a heating device, as shown in FIGS. 1 to 6. For this purpose, the outer end 610a has in particular a smaller diameter than the longitudinal bore 170, 180. Preferably, the outer end 610a also has a receptacle 612 for sealing rings or the like.

The inner end 610c has a bayonet ring 632. The bayonet ring 632 is characterized in particular by the fact that it has two openings 632a for corresponding bayonet pins.

FIG. 8 shows a second connecting element 620 in one embodiment, in particular in a female embodiment 620f.

The second connecting element 620 is formed in sections as a cylindrical body 620b and has an outer end 620a and an inner end 620c. In addition, the cylindrical body 620b comprises a curvature K, which is designed in particular such that the openings of the ends 620a, 620c are arranged orthogonally to one another.

Preferably, the outer end 620a further comprises a receptacle 622 for sealing rings or the like and is adapted to be connected to one end 610c of a first connector 610, as shown for example in FIG. 7.

A bayonet ring 632 together with openings 632a, 632a is also provided at the inner end 620c, which is arranged to receive bayonet pins 634 of another second connecting element 620, as shown in particular in FIG. 9.

FIG. 9 shows a second connecting element 620 in one embodiment, in particular in a male embodiment 620ₘ.

The second connecting element 620 is formed in sections as a cylindrical body 620_{b}and has an outer end 620ₐ and an inner end 620_{c.} In addition, the cylindrical body 620_{b} comprises a curvature K, which is designed in particular such that the openings of the ends 620_{a,} 620_{c} are arranged orthogonally to one another.

Preferably, the outer end 620ₐ further comprises a receptacle 622 for sealing rings or the like and is adapted to be connected to one end 610_{c} of a first connector 610, as shown for example in FIG. 7.

Two bayonet pins 634, 634 are also arranged at the inner end 620_{c} in order to connect the second connecting element to another connecting element 620, as shown in particular in FIG. 8.

FIG. 10 shows a connecting piece 600 in a preferred embodiment.

The connecting piece 600 comprises two first connecting elements 610 and two second connecting elements 620_{m,} 620_{f}.

A first connecting element 610 is connected via the inner end 610_{c} to the male second connecting element 620_{m,} in particular to the outer end 620ₐ.

A second connecting element 610 is connected via the inner end 610_{c} to the female second connecting element 620_{f,} in particular to the outer end 620ₐ.

The male second connecting element 620ₘ is in turn connected to the female second connecting element 620_{f} via corresponding inner ends 620_{c}.

The connection between the connecting elements 610, 610, 620_{f,} 620ₘ is made in particular via a bayonet catch, in particular as shown in FIGS. 7 to 9.

The connecting elements 610 are preferably designed as shown in FIG. 7. The connecting element 620f is preferably designed as shown in FIG. 8. The connecting element 620m is preferably designed as shown in FIG. 9

FIG. 11 shows a section of a heating device 10 in a preferred embodiment.

The heating device 10 comprises a heating element 100 which is connected to a further heating element 100 in a fluid-conducting manner via two connecting pieces 600.

The design of the bayonet catches according to the invention results in a longitudinal play L.

### LIST OF REFERENCE SYMBOLS

10 skirt heating system
100 heating module
110 first side
120 second side
130 third side
131 first fins
132 slat valleys
133 third lamellae
140 fourth side
141 arm
142 outer side
143 curved section
144 volume
150 area
151 volume
152 first end
153 second end
155 bar
160 fastening sections
170 first longitudinal holes
180 second longitudinal holes
190 second fins
191 mounds of fins
192 vane valleys
193 third fins
200 holding bracket
210 base
220 retaining body
221 hole
222 recesses
230 arms
300 corner cover
400 corner cover
500 end caps
600 connecting piece, in particular fitting
610 first connecting element, in particular of the connecting piece
610a outer end, in particular of the first connecting element
610b body, in particular of the first connecting element
610c inner end, in particular of the first connecting element
612 holder for sealing rings
614 taper
620 second connecting element, in particular of the connecting piece
620a outer end, in particular of the second connecting element
620b body, in particular of the second connecting element
620c inner end, in particular of the second connecting element
622 holder for sealing rings
624 taper
630 bayonet lock, in particular of the connecting piece
632 bayonet ring
632a opening in the bayonet ring
634 bayonet pin
700 retaining spring
710 first end
711 first arm
712 third arm
720 second end
721 second arm
722 fourth arm
730 first section
740 second section
760 third section
770 middle section
800 Wall
K curving
L longitudinal play, in particular for linear play

1. Heating device, with
at least one heating module which has first and second sides which are each substantially straight and parallel to one another,
wherein the heating module has a third side with a plurality of first fins and a fourth side with a plurality of second fins and an arm provided at a distance from the second fins,
wherein the heating module has first and second longitudinal bores for receiving a heating medium,
wherein each heating module is manufactured in one piece in the form of an aluminum extrusion process.

2. Heating device according to claim 1, wherein
the heating module has a weight of between 2 and 3 kilograms per meter.

3. Heating device according to claim 1, wherein
a heating module has a specific standard heat output of between 125 and 140 watts per meter and, in particular, a specific standard heat output of approximately 130 watts per meter.

4. Heating device according to claim 1, wherein
the arm is straight on its outer side and has a curved section on its opposite side, which points towards second slats.

5. Heating device according to claim 4, wherein
a surface of first slats of the third side, the a surface of the second slats and/or a surface of a curved section of the arm each has a corrugation.

6. Heating device according to claim 1, comprising
a central portion having a first end at the first side and a second end at the second side,
whereby the middle section can serve as a cable duct.

7. Heating device according to claim 6, wherein the second end of the middle section is designed to be open or closed.

8. Heating device according to claim 4, wherein
the heating module has a depth,
wherein a length of the arm measured from the second side substantially corresponds to the depth of the heating module.

9. Heating device according to claim 4, wherein
an outer side of the arm has an angle to the second side of between 90° and 100°.

10. Heating device according to claim 1, further comprising
at least one retaining bracket, which can be attached to a wall,
wherein the at least one retaining bracket is attached to the first side of the heating module, so that there is a distance between the first side of the heating module and the wall, which distance is determined by the retaining bracket.

11. Connecting piece for a strip heater, comprising
a first connecting element; and
a second connecting element, wherein
the first connecting element and the second connecting element can be connected to one another in a fluid-conducting manner via a bayonet catch.

12. Connecting piece according to claim 11, wherein the bayonet catch is an integral part of the first and second connecting element.

13. Connecting piece according to claim 11, wherein the bayonet catch is designed in such a way that the second connecting element comes to rest in the first connecting element in a fluid-conducting manner.

14. Connecting piece according to claim 11, wherein
the bayonet catch is designed in such a way that the second connecting element has a longitudinal play (L) within the first connecting element, which is orthogonal to an axis of rotation of the bayonet catch.

15. Connecting piece according to claim 11, wherein
the first connecting element and/or the second connecting element are substantially or sectionally tubular or cylindrical.

16. Connecting piece according to claim 11, wherein
the second connecting element has a curvature (K) which is designed in particular in such a way that the openings of the ends are arranged orthogonally to one another and/or a heating fluid flowing through the second connecting element has a horizontal flow direction in sections and a vertical flow direction in sections.

17. Connecting piece according to claim 11, comprising:
two second connecting elements, which are connected to each other in such a way that a heating fluid flowing through the second connecting elements has a horizontal flow direction in sections and a vertical flow direction in sections and a repeated horizontal flow direction in sections.

18. Connecting piece according to claim 11, comprising:
two first connecting elements and two second connecting elements.

19. Connecting piece according to claim 11, wherein
is designed as a pipe connector or fitting to connect two heating modules of a skirt heating system, in particular comprising two first connecting elements and two second connecting elements.

20. Connecting piece according to claim 19, wherein a second connecting element is female and a second connecting element is male, and the connecting elements are connected to one another via an integral bayonet catch.

21. (canceled)
